(19) United States
(12) Patent Application Publication
(10) Pub. No.: US 2026/0091473 A1
(43) Pub. Date: Apr. 2, 2026

(54) OIL FILTER WRENCH

(71) Applicant: Robert Bosch GmbH, Stuttgart (DE)

(72) Inventor: Daniel Newkirk, Owatonna, MN (US)

(21) Appl. No.: 18/901,425

(22) Filed: Sep. 30, 2024

(51) Int. Cl. B25B 27/00; B25B 13/50; B25B 23/00

(52) U.S. Cl. CPC B25B 27/0042; B25B 13/5008; B25B 23/0021; B25B 23/0035

(57) ABSTRACT

An oil filter wrench with a reservoir attachment. The reservoir attachment captures and collects oil spilled during service of a vehicle. The reservoir comprises a number of ports, including a shaft port to accommodate a handle extension transferring torque from a torque handle to a torque head. The reservoir may further comprise a drain port configured to shunt oil away in larger volumes for collection or disposal.

### TECHNICAL FIELD

This disclosure relates to handheld tools. More particularly, this disclosure relates to handheld tools for automotive service.

### BACKGROUND

Motor vehicles utilizing engine oil must be regularly serviced, including changing of the engine oil. Vehicles utilizing engine oil will make use of an oil filter to help protect the engine from contaminants. During service of the engine that requires removal of the oil filter, oil may spill down the sides of the filter. In professional service settings, the engine may have been recently operating, and the oil may be hot. Thus, spillage of the oil is undesirable for reasons of safety for a service user as well as preventing a mess requiring cleanup.

What is desired is a tool that will aid in oil filter removal without exposing the service user to hot oil. It is additionally desired for a tool that will minimize or contain oil spillage during service of the vehicle.

### SUMMARY

One aspect of this disclosure is directed to a wrench assembly comprised of a wrench and a reservoir. The wrench has a torque handle, a handle extension, and a torque head. The torque head comprises a grip surface to engage a target body and transfer torque to the target body. The handle extension comprises a proximal end and a distal end. The handle extension detachably couples to the torque handle at the proximal end. The handle extension detachably couples to the torque head at the distal end. The reservoir has a reservoir housing defining a receptacle opening. The reservoir is supported by the wrench and disposed between the torque handle and the torque head when the wrench assembly is assembled. When the wrench assembly is assembled, the reservoir is oriented such that the receptacle opening is nearer to the torque head than the torque handle. In some embodiments, the reservoir body may comprise a shaft port suitable through which the handle extension may be threaded during assembly. In some such embodiments, the reservoir may further comprise a shaft gasket fitting the shaft port such that a liquid-tight seal is created between the handle extension and the shaft port. In some embodiments, the reservoir body may comprise a drain port. In some embodiments, a nozzle may be disposed within the drain port. In some such embodiments the reservoir may further comprise a drain gasket fitting the drain port such that a liquid-tight seal is created between the drain port and the nozzle.

Another aspect of this disclosure is directed to a reservoir attachment for a tool, the reservoir attachment comprising a reservoir housing having a baffle and a boundary surface. The reservoir attachment further may comprise a drain port disposed within the reservoir housing. The reservoir attachment may further comprise a shaft port disposed within the reservoir housing. The shaft port is sized to accommodate the diameter of a tool component.

The above aspects of this disclosure and other aspects will be explained in greater detail below with reference to the attached drawings.

### BRIEF DESCRIPTION OF THE DRAWINGS

FIG. 1 is a diagrammatic view of an oil change service operation for a vehicle.

FIG. 2 is a view of an oil filter cartridge of a vehicle in-situ from an underside perspective.

FIG. 3 is an illustration of an oil filter wrench engaging an oil filter cartridge.

FIG. 4 is an exploded view of the oil filter wrench of FIG. 3.

FIG. 5 is an alternative view of the oil filter wrench of FIG. 3.

FIG. 6 is an alternative view of the reservoir of the filter wrench of FIG. 3.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

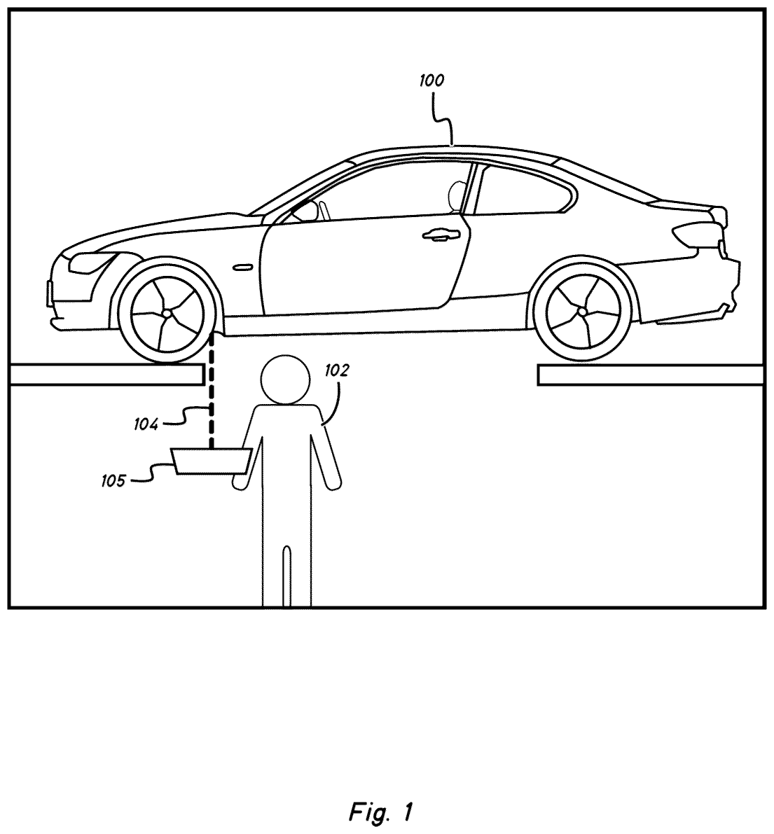

FIG. 1 is a diagrammatic depiction of an oil change service for a vehicle 100 by a service user 102 in a professional setting. The motor oil of vehicle 100 is released via oil drainage 104 into a collection receptacle 105. In a professional setting, vehicle 100 may be serviced rapidly upon arrival to the location of service, and as a result, fluids within vehicle 100 may be hot. Additionally, fluids such as motor oil spill during service, creating messy conditions for service user 102. These service operations must therefore be accomplished with care in order to optimize safety of service worker 102.

In the depicted embodiment, vehicle 100 comprises a consumer sedan, but other embodiments may comprise other vehicles without deviating from the teachings disclosed herein. Such embodiments may comprise a coupe, compact car, motorcycle, motor scooter, cargo van, minivan, truck, light truck, sport-utility vehicle, crossover vehicle, limousine, or any other vehicle utilizing one or more fluids that may require interaction by a service user during a service operation.

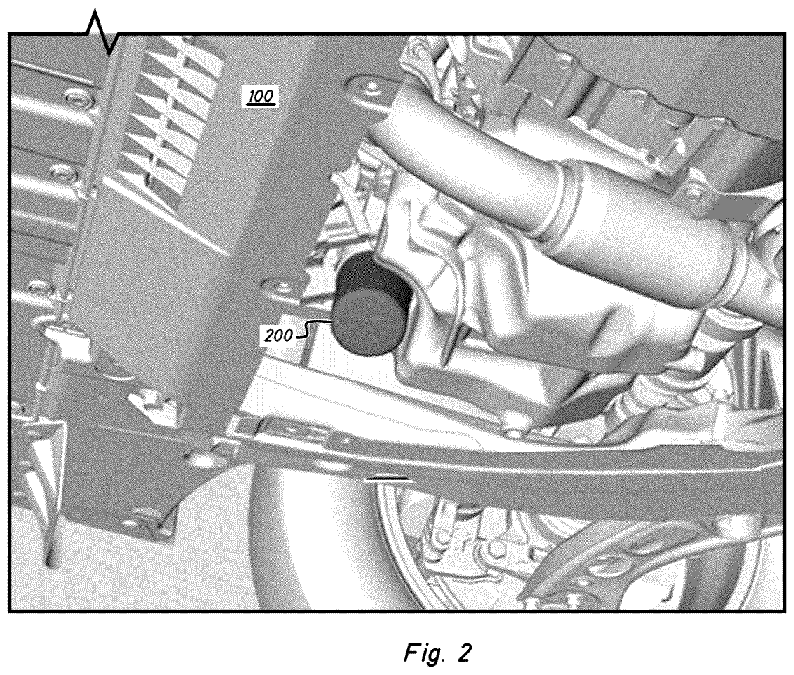

During a service operation of an oil change, an oil filter of vehicle 100 may be removed, which may additionally be source of oil drainage 104. Because service user 102 is below vehicle 100 during the service operation for convenience of the customer, gravity is a concern for oil drainage 104, as the motor oil (or other fluids) may drain towards service user 102. Other conditions are a consideration for the service of oil changes in vehicle 100. FIG. 2 is a depiction of vehicle 100 from a bottom-up perspective, looking at its oil filter cartridge (often simplified to “oil filter”) 200 in situ. The placement of oil filter 200 may be difficult for service user 102 to screw or unscrew oil filter 200 with bare hands because of tight working spaces along the under-carriage of vehicle 100. A tool is desired to provide a user with a way of handling and maneuvering the oil filter 200 without directly interacting with any component of vehicle 100 by hand.

In the depicted embodiment, oil filter 200 is disposed along the under-carriage of vehicle 100 with a downward-facing orientation, but other embodiments may comprise an oil filter disposed differently within a vehicle or oriented differently without deviating from the teachings disclosed herein.

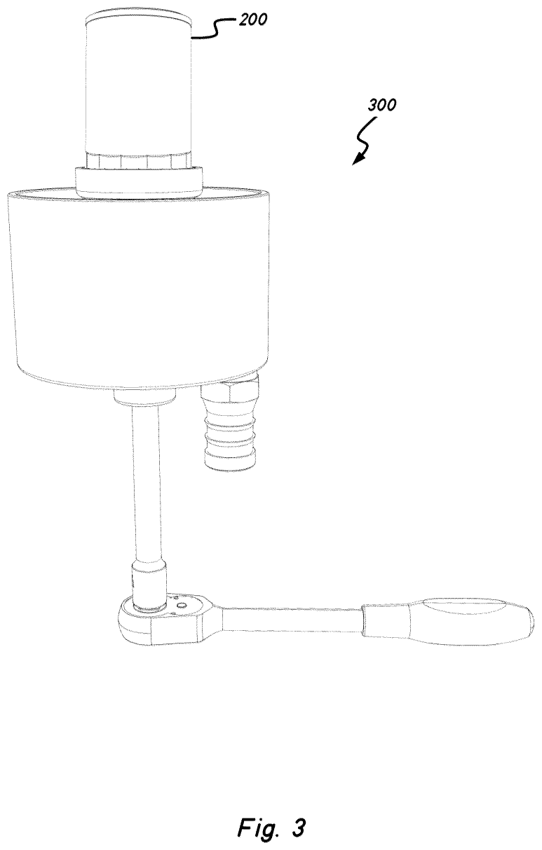

FIG. 3 depicts oil filter 200 engaged by an oil filter wrench assembly (hereinafter shortened to “wrench assembly”) 300. Wrench assembly 300 comprises features designed to provide a user with the ability to handle and maneuver a target body (such as the oil filter 200) in situ without directly interacting with the surrounding components of vehicle 100 (not shown; see FIG. 2) by hand, and additionally comprises features designed to prevent oil spillage onto the user, the other components of the vehicle, or the surrounding environment during service.

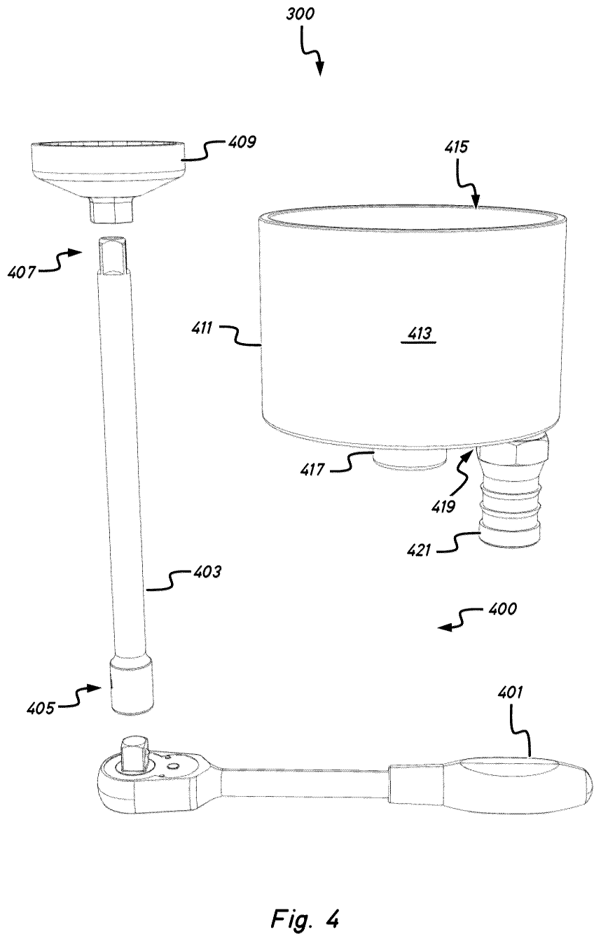

FIG. 4 is an exploded view of wrench assembly 300, providing additional illustrations of its various components. Wrench assembly 300 comprises wrench 400. Wrench 400 comprises a torque handle 401 suitable to provide a user a way to engage the wrench 400, including applying torque. In the depicted embodiment, torque handle 401 comprises a single-handed, square-bit, ratcheting torque wrench, but other embodiments may comprise other configurations without deviating from the teachings disclosed herein. In such embodiments, torque handle 401 may comprise a two-handed configuration, a non-ratcheting configuration, a different length, a different bit driver configuration, or any other configuration known to one of ordinary skill without deviating from the teachings disclosed herein.

Wrench 400 further comprises a handle extension 403. Torque handle 401 engages with handle extension 403. Handle extension 403 advantageously provides space to distance the user from a target body (such as oil filter 200; See FIG. 2) and potential spilled oil during service while still permitting the user to apply torque necessary to loosen or tighten the filter. In the depicted embodiment, handle extension 403 comprises a proximal end 405 and a distal end 407, but other embodiments may comprise other configurations without deviating from the teachings disclosed herein.

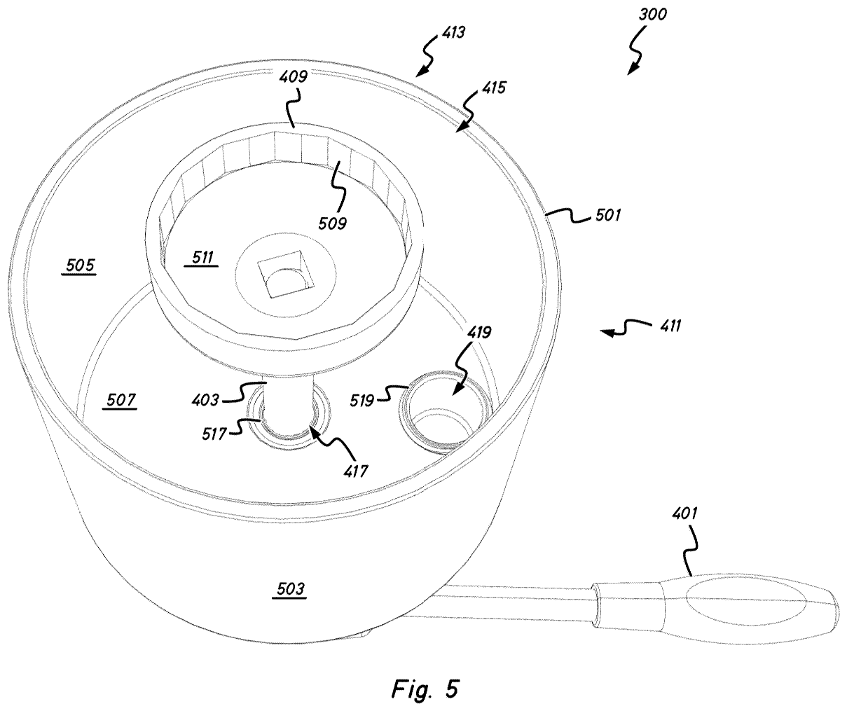

Wrench 400 further comprises a torque head 409. In the depicted embodiment, proximal end 405 engages with torque handle 401, while the distal end 407 engages with a torque head 409. Torque head 409 engages with an oil filter directly during service. During service torque is transferred from torque handle 401 to handle extension 403, and subsequently transferred from handle extension 403 to torque head 409. Additional features of torque head 409 will be discussed later with respect to FIG. 5.

Wrench assembly 300 additionally comprises a reservoir 411, depicted in this embodiment as a detachable reservoir attachment, but other embodiments may comprise non-detachable configurations without deviating from the teachings disclosed herein. Reservoir 411 is configured to “catch” any oil drips during service, collecting loose oil and preventing spillage onto a user, other components of a vehicle under service, or onto the surrounding environment. Reservoir 411 comprises a reservoir housing 413 that defines a receptacle opening 415 through which oil is captured during service. In the depicted embodiment, when wrench 300 is fully assembled, reservoir 411 is aligned such that the receptacle opening 415 is closer to the distal end 407 of handle extension 403 (and subsequently oriented toward torque head 409 and the oil filter under service) than the proximal end 405. Other embodiments may comprise other configurations with different preferred alignments without deviating from the teachings disclosed herein. In the depicted embodiment, reservoir 411 comprises a cylindrical silhouette, but other embodiments may comprise any shape without deviating from the teachings disclosed herein.

During assembly of wrench assembly 300, handle extension 403 passes through reservoir 411 (see, e.g., FIG. 3) via a shaft port 417 disposed within reservoir housing 413. Shaft port 417 is suitable in size to receive a component of a tool (such as handle extension 403). In the depicted embodiment, shaft port 417 is disposed such that handle extension 403 is disposed along a center axis of the volume of reservoir 411, but other embodiments may comprise different configurations having different placements without deviating from the teachings disclosed herein.

In the depicted embodiment, reservoir 411 additionally comprises a drain port 419 defined within reservoir housing 413 suitable to permit drainage of spilled oil. Drain port 419 advantageously provides a user with the ability to capture and direct a large amount of oil during service without being concerned with the total volume of oil being larger than the volume of reservoir 411. In the depicted embodiment, drain port 419 is coupled to a nozzle 421 suitable to fit a drainage tube or hose. In the depicted embodiment, nozzle 421 is disposed at least partially within drain port 419, but other embodiments may comprise other configurations without deviating from the teachings disclosed herein. Some embodiments may not comprise a drain port 419 or a nozzle 421 without deviating from the teachings disclosed herein. Some embodiments may comprise a different number, or a different placement, of drain ports 419 or nozzles 421 without deviating from the teachings disclosed herein.

FIG. 5 is an alternative view of assembled wrench assembly 300 illustrating additional features. Reservoir 411 comprises a baffle 501, which acts as a containing structure to capture spilled oil during surface. Baffle 501 comprises an exterior surface 503 and an interior surface 505 that directly comes into contact with spilled oil. Coupled to interior surface 505 is a boundary surface 507 that acts as an additional capturing boundary for spilled oil. During service, boundary surface 507 primarily stops spillage of oil in a downward direction past the reservoir, while interior surface 505 primarily contains and collects accumulated oil by preventing spillage in a lateral direction.

Torque head 409 additionally comprises a grip surface 509 and a support surface 511. Grip surface 509 transfers torque from the torque head 409 to a target body (such as oil filter 200; see FIG. 2) during service. Support surface 511 engages and supports an oil filter during service in order to give the user control of the application of torque and prevent a loosened oil filter from falling during service.

It is additionally observed from this view that handle extension 403 passes through reservoir 411 via shaft port 417. Because contained oil is in liquid form, additional features of reservoir are implemented to prevent leakage at the ports disposed within boundary surface 507.

In the depicted embodiment, shaft port 417 is fitted with a shaft gasket 517. Shaft gasket 517 is fitted such that the seal between shaft port 417 and handle extension 403 is liquid-tight when handle extension 403 is received through shaft port 417. In the depicted embodiment, shaft gasket 517 is made of an elastomer that repels motor oil, but other embodiments may comprise other materials providing a liquid-tight seal to motor oil without deviating from the teachings disclosed herein. In the depicted embodiment, both shaft gasket 517 and shaft port 417 have a circular shape, but other embodiments may comprise different geometries without deviating from the teachings disclosed herein.

In the depicted embodiment, drain port 419 is fitted with a drain gasket 519. Drain gasket 519 is fitted such that the seal between the drain port 419 and nozzle 421 (not shown; see FIG. 4) is liquid-tight, thus shunting all captured oil through the port for collection or disposal. In the depicted embodiment, drain gasket 519 is made of an elastomer that repels motor oil, but other embodiments may comprise other materials providing a liquid-tight seal to motor oil without deviating from the teachings disclosed herein. In the depicted embodiment, both drain gasket 519 and drain port 419 have a circular shape, but other embodiments may comprise different geometries without deviating from the teachings disclosed herein.

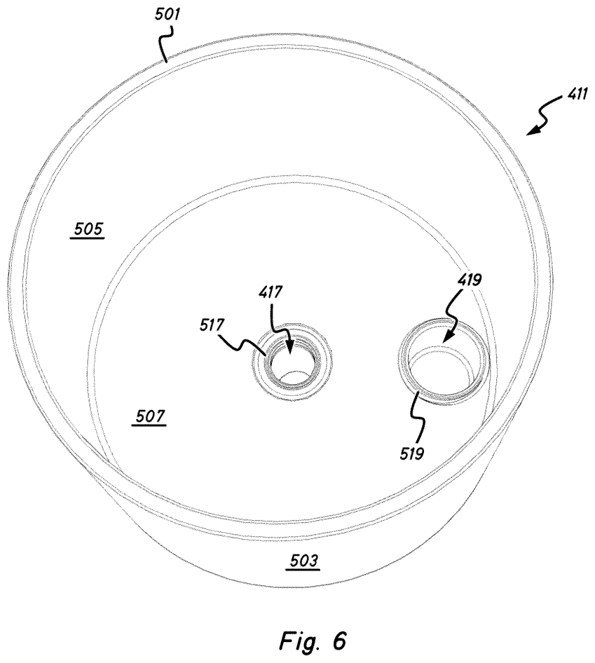

FIG. 6 is an illustration of just reservoir 411 from the same viewing angle as provided in FIG. 5. In this illustration, the features of reservoir 411 can be viewed in detail without any obstruction from the additional components of wrench 300 assembly (see FIG. 3, FIG. 4, FIG. 5).

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A wrench assembly comprising:
a wrench having
a torque handle,
a handle extension having a proximal end and a distal end, and
a torque head; and
a reservoir having a reservoir housing and supported by the wrench,
wherein
the torque head comprises a grip surface to engage a target body and transfer torque to the target body,
the handle extension detachably couples to the torque handle at the proximal end,
the handle extension detachably couples to the torque head at the distal end,
the reservoir is disposed between the torque handle and the torque head,
the reservoir housing defining a receptacle opening, and
the reservoir is oriented between the torque handle and the torque head such that the receptacle opening is nearer to the torque head than the torque handle.

2. The wrench assembly of claim 1, wherein the reservoir further comprises a drain port disposed nearer to the torque handle than the torque head.

3. The wrench assembly of claim 2, further comprising a nozzle disposed in the drain port.

4. The wrench assembly of claim 3, wherein the reservoir comprises a drain gasket fitting with a liquid-tight seal between the drain port and the nozzle.

5. The wrench assembly of claim 1, wherein the reservoir comprises a shaft port, the handle extension passing through the shaft port.

6. The wrench assembly of claim 5, wherein the reservoir comprises a shaft gasket fitting with a liquid-tight seal between the shaft port and the handle.

7. The wrench assembly of claim 1, wherein
the reservoir comprises a drain port and a shaft port,
the drain port is disposed nearer to the torque handle than the torque head, and
the handle extension passes through the shaft port.

8. The wrench assembly of claim 7, wherein the reservoirs further comprises a shaft gasket, the shaft gasket fitting with a liquid-tight seal between the shaft port and the handle extension.

9. The wrench assembly of claim 8, wherein the reservoir further comprises
a nozzle disposed within the drain port; and
a drain gasket fitting with a liquid-tight seal between the drain port and the nozzle.

10. A reservoir attachment comprising:
a reservoir housing having
a baffle with an interior surface and an exterior surface, the baffle further defining a receptacle opening, and
a boundary surface coupled to the interior surface and disposed opposite the receptacle opening;
a drain port disposed within the reservoir housing; and
a shaft port disposed within the reservoir housing,
wherein
the shaft port is sized to accommodate the diameter of a tool component.

11. The reservoir attachment of claim 10, further comprising a nozzle disposed within the drain port.

12. The reservoir attachment of claim 10, further comprising a drain gasket, the drain gasket fitting with a liquid-tight seal between the drain port and the nozzle.

13. The reservoir attachment of claim 10, further comprising a shaft gasket, the shaft gasket fitting with a liquid-tight seal between the shaft port and the handle extension.

14. The reservoir attachment of claim 13, wherein the reservoir further comprises a nozzle disposed within the drain port.

15. The reservoir attachment of claim 14, wherein the reservoir further comprises a drain gasket, the drain gasket fitting with a liquid-tight seal between the drain port and the nozzle.
